(19) United States
(12) Patent Application Publication
(10) Pub. No.: US 2014/0198873 A1
(43) Pub. Date: Jul. 17, 2014

(54) COMMUNICATION DEVICE

(71) Applicant: FAIRCHILD KOREA SEMICONDUCTOR LTD., Bucheon-si (KR)

(72) Inventors: Kyoungmin LEE, Seoul (KR); Jaehyun HAN, Seoul (KR); Ikgyoo SONG, Incheon (KR)

(73) Assignee: FAIRCHILD KOREA SEMICONDUCTOR LTD., Bucheon-si (KR)

(21) Appl. No.: 14/155,753

(22) Filed: Jan. 15, 2014

(30) Foreign Application Priority Data
Jan. 15, 2013 (KR) 10-2013-0004601

(51) Int. Cl. H04L 7/00

(52) U.S. Cl. CPC H04L 7/0016
USPC 375/285

(57) ABSTRACT

An exemplary embodiment relates to a communication device. A communication device includes: a transmitting unit generating a first analog signal and a second analog signal based on an input signal; and a receiving unit including a first capacitor having a first terminal to which the first analog signal is input and a second capacitor having a first terminal to which the analog signal is input. The receiving unit constantly controls a reference voltage electrically coupled with a second terminal of the first capacitor and a second terminal of the second capacitor, and generating an output signal based on a result of comparison between a first pulse signal generated at the second terminal of the first capacitor and a second pulse signal generated at the second terminal of the second capacitor.

### CROSS-REFERENCE TO RELATED APPLICATION

This application claims priority to and the benefit of Korean Patent Application No. 10-2013-0004601 filed in the Korean Intellectual Property Office on Jan. 15, 2013, the entire contents of which are incorporated herein by reference.

### BACKGROUND

(a) Field

An exemplary embodiment relates to a communication device. Particularly, it relates to a communication device that transmits and receives data through a capacitor barrier.

(b) Description of the Related Art

A capacitor formed in a transmitting and receiving path through which data is transmitted and received is referred to as a capacitor barrier. In this case, a transmitting terminal and a receiving terminal need to be synchronized. In order to prevent data distortion, the receiving terminal should be synchronized at the time that the data is transmitted and receive the data.

For synchronization between the transmitting terminal and the receiving terminal, the transmitting terminal may transmit a signal including data, together with a clock together. Alternatively, the transmitting terminal may encode the data signal and transmit the encoded signal, and the receiving terminal may receive the encoded signal and decode the received signal.

When the data signal is transmitted together with the clock signal, the amount of transmitting is increased and a circuit of each of the transmitting terminal and the receiving terminal is increased for data encoding and decoding.

The above information disclosed in this Background section is only for enhancement of understanding of the background of the invention and therefore it may contain information that does not form the prior art that is already known in this country to a person of ordinary skill in the art.

### SUMMARY

An exemplary embodiment is related to provide a communication device that can perform data transmitting and receiving with a simple structure through an exemplary embodiment.

A communication device according to an exemplary embodiment includes: a transmitting unit being configured to generate a first analog signal and a second analog signal based on an input signal; and a receiving unit including a first capacitor having a first terminal to which the first analog signal is input and a second capacitor having a first terminal to which the analog signal is input. The receiving unit constantly controls a reference voltage electrically coupled with a second terminal of the first capacitor and a second terminal of the second capacitor, and generating an output signal based on a result of comparison between a first pulse signal generated at the second terminal of the first capacitor and a second pulse signal generated at the second terminal of the second capacitor.

The receiving unit includes a comparator that compares the first pulse signal with the second pulse signal and outputs a result of the comparison.

The receiving unit further includes a first resistor coupled between the second terminal of the first capacitor and the reference voltage and a second resistor coupled between the second terminal of the second capacitor and the reference voltage, and the first pulse signal is generated from a node where the first capacitor and the first resistor are coupled and the second pulse signal is generated from a node where the second capacitor and the second resistor are coupled.

The comparator is configured to ignore a voltage variation generated in inputs of the comparator when the voltage variation is lower than a predetermined threshold voltage.

The threshold voltage is set to be a voltage that is greater than a voltage variation generated in the first pulse signal by a smaller slope among an increasing slope and a decreasing slope of the first sawtooth wave signal and a voltage variation generated in the second pulse signal by a smaller slope among an increasing slope and a decreasing slope of the second sawtooth wave signal.

The receiving unit further includes a reference generator generating the reference voltage, and the reference voltage generator includes an output node where the reference voltage is generated, a first Darlington pair including an output terminal coupled to the output node and constantly controlling the reference voltage when the first analog signal is decreased, a second Darlington pair including an output terminal coupled to the output node and constantly controlling the reference voltage when the first analog signal is increased, a first source follower including an output terminal coupled to an input terminal of the first Darlington pair, a second source follower including an output terminal coupled to an input terminal of the second Darlington pair, and a first control voltage source coupled between the input terminal of the first source follower and the input terminal of the second source follower.

The reference generator further includes a third resistor coupled between the first source follower and a first voltage and a fourth resistor coupled between the second source follower and a ground.

A voltage of the first control voltage source is set to control the minimum amount of current to be generated from later ends of each of the third and fourth resistors.

The second source follower includes a first MOSFET including a drain coupled to a first end of the third resistor, a gate to which a second voltage of the first control voltage source is supplied, and a source coupled to an input terminal of the first Darlington pair.

The second source follower includes a second MOSFET including a drain coupled to a first end of the fourth resistor, a gate to which a third voltage of the first control voltage source is supplied, and a source coupled to an input terminal of the second Darlington pair.

A second end of the third resistor is coupled to the first voltage and a second end of the fourth resistor is coupled to a ground.

The first Darlington pair includes a first BJT including an emitter coupled to the output node, a collector coupled to a first voltage, and a base coupled to a first node and a third BJT including an emitter coupled to the first node, a collector coupled to the first voltage, and a base coupled to an input terminal of the first Darlington pair.

The second Darlington pair includes a second BJT including an emitter coupled to the output node, a collector coupled to a ground, and a base coupled to a second node and a fourth BJT including an emitter coupled to the second node, a collector coupled to the ground, and a base coupled to an input terminal of the second Darlington pair.

The reference generator further includes a third control voltage source coupled between the first node and the second node, and a voltage the third control voltage source is set to be lower than the sum of a voltage difference between the base and the emitter of the first BJT and a voltage difference between the base and the emitter of the second BJT.

The reference generator further includes a second control voltage source coupled between the input terminal of the first Darlington pair and the input terminal of the second Darlington pair, and a voltage of the second control voltage source is set to be lower than the sum of a voltage difference between the base and the emitter of the third BJT, a voltage difference between the base and the emitter of the fourth BJT, and the voltage of the third control voltage source.

The first analog signal depends on one of a first waveform and a second waveform based on the input signal, the absolute value of an increasing slope and the absolute value of a decreasing slope of the first analog signal are difference from each other in the first waveform, and the absolute value of the increasing slope and the absolute value of the decreasing slope of the first analog signal are difference from each other in the second waveform.

The second analog signal depends on one of a third waveform and a fourth waveform based on the input signal, the absolute value of an increasing slope and the absolute value of a decreasing slope of the second analog signal are difference from each other in the third waveform, and the absolute value of the increasing slope and the absolute value of the decreasing slope of the second analog signal are difference from each other in the fourth waveform.

The receiving unit further includes: a first resistor coupled between the second end of the first capacitor and the reference voltage; a second resistor coupled between the second end of the second capacitor and the reference voltage; and a reference generator generating a current to offset a pulse of the first pulse signal and a pulse of the second pulse signal when the pulse of the first pulse signal and the pulse of the second pulse have the same direction.

When both of the first pulse signal and the second pulse signal have high-level pulses, the reference generator is configured to generate a first sink current flowing to the reference generator through the first resistor and a second sink current flowing to the reference generator through the second resistor.

When both of the first pulse signal and the second pulse signal have low-level pulses, the reference generator is configured to generate a first source current flowing to the second end of the first capacitor through the first resistor and a second source current flowing to the second end of the second capacitor through the second resistor.

The receiving unit further includes a comparator that includes a first input terminal to which the first pulse signal is input and a second input terminal to which the second pulse signal is input, is configured to generate the output signal based on a result of comparison between the first pulse signal and the second pulse signal, and ignores a voltage variation generated in the first pulse signal and the second pulse signal when the voltage variation is lower than a predetermined threshold voltage.

When the input signal indicates data 1, a current flows to the second end of the second capacitor from the second end of the first capacitor through the first resistor and the second resistor. When the input signal indicates data 0, a current flows to the second end of the first capacitor from the second end of the second capacitor through the second resistor and the first resistor.

According to the exemplary embodiment, a communication device that can transmit/receive data with a simple structure can be provided.

Since data is transmitted and received by using an analog signal such as a sawtooth wave, the communication device can be realized with further simple structure compared to using a digital pulse. For example, a clock signal for matching a transmitting side and a receiving side is not required. In addition, when the clock signal is not used, the data needs not to be encoded with a pulse width signal (PWM) or a predetermined pattern.

Further, a current consumption in generation of a reference signal can be minimized.

### BRIEF DESCRIPTION OF THE DRAWINGS

FIG. 1 shows a transmitting device and a receiving device of a communication device according to an exemplary embodiment.

FIG. 2 is a waveform observed when the communication device according to the exemplary embodiment transmits and receives data 1.

FIG. 3 is a waveform illustrating when the communication device according to the exemplary embodiment transmits and receive data 0.

FIG. 4 shows a current path formed when a common-mode noise is generated in a positive direction and is provided for description of the exemplary embodiment.

FIG. 5 shows a current path formed when the common-mode noise is generated in a negative direction and is provided for description of the exemplary embodiment.

FIG. 6 shows a current path formed when data 1 is transmitted and received according to the exemplary embodiment.

FIG. 7 shows a current formed when data 0 is transmitted and received according to the exemplary embodiment.

FIG. 8 partially shows a reference generator according to the exemplary embodiment.

### DETAILED DESCRIPTION OF THE EMBODIMENTS

In the following detailed description, only certain exemplary embodiments have been shown and described, simply by way of illustration. As those skilled in the art would realize, the described embodiments may be modified in various different ways, all without departing from the spirit or scope. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

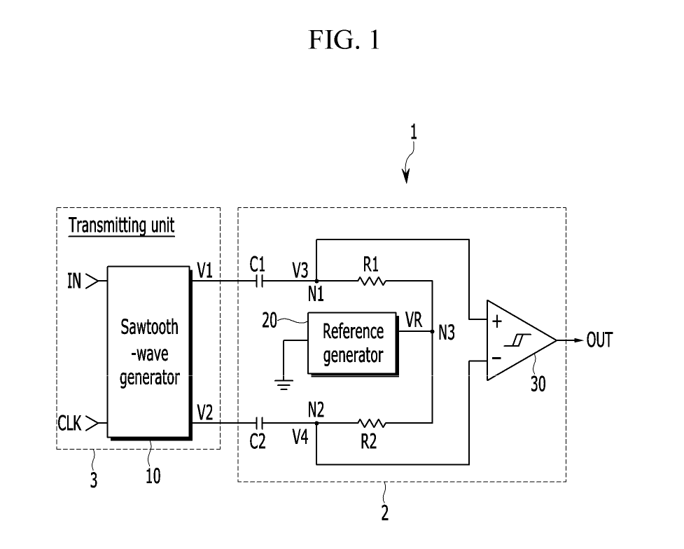

FIG. 1 shows a transmitting device and a receiving device of a communication device according to an exemplary embodiment.

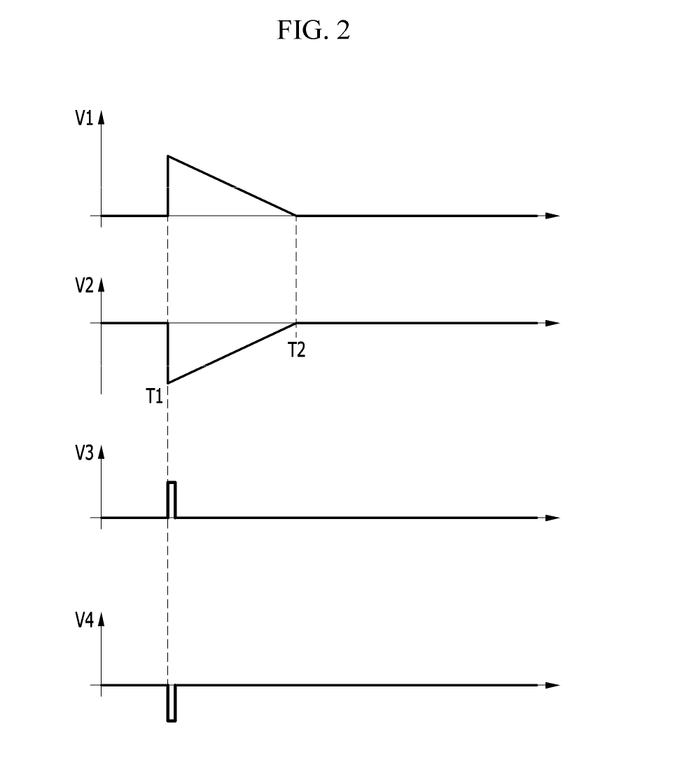

FIG. 2 shows a waveform formed when the communication device according to the exemplary embodiment transmits and receives data 1.

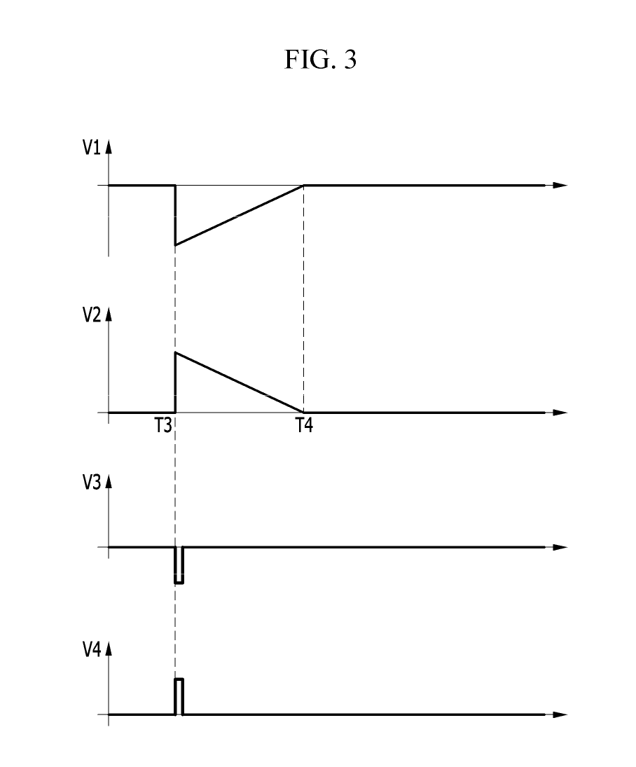

FIG. 3 shows a waveform formed when the communication device according to the exemplary embodiment transmits and receives data 0.

A communication device 1 includes a receiving unit 2 and transmitting unit 3.

The transmitting unit 3 receives an input signal IN and a clock signal CLK, and generates a first analog signal and a second analog signal. In the exemplary embodiment the first analog signal is exemplarily set as a first sawtooth-wave signal V1 and the second analog signal is exemplarily set as a second sawtooth-wave signal V2. The input signal IN is a signal including data, and the clock signal CLK is a signal controlling a sampling time point of the input signal IN. For example, the transmitting unit 3 includes a sawtooth-wave generator 10. The sawtooth-wave generator 10 is enabled by a high-level clock signal CLK and thus samples the input signal IN. The sawtooth-wave generator 10 generates a first sawtooth-wave signal V1 and a second sawtooth-wave signal V2 according to a level of the sampled input signal IN.

When a level of the sampled input signal IN is high level that indicates the logic “1”, the sawtooth-wave generator 10 generates the first sawtooth-wave signal V1 and the second sawtooth-wave signal V2 shown in FIG. 2. In further detail, the first sawtooth-wave signal V1 has a waveform that is increased to high level and then decreases with a constant slope, and the second sawtooth-wave signal V2 has a waveform that decreases to low level and then increases with a constant slope.

When a level of the sampled input signal IN is low level indicating the logic “0”, the sawtooth-wave generator 10 generates a first sawtooth-wave signal V1 and a second sawtooth-wave signal V2 of FIG. 3. In detail, the first sawtooth-wave signal V1 has a waveform that is increased with a constant slope after being decreased to a low level, and the second sawtooth-wave signal V2 has a waveform that is decreased with a constant slope after being increased to a high level.

The transmitting unit 3 according to the exemplary embodiment generates the first sawtooth-wave signal V1 and the second sawtooth-wave signal V2 according to the input signal IN and the clock signal CLK, but the exemplary embodiment is not limited thereto. A signal of which the absolute value of an increasing slope and the absolute value of a decreasing slope are different from each other may be applied as a signal output from the transmitting unit 3. In this case, a waveform of the signal is different from the waveforms shown in FIG. 2 and FIG. 3.

The receiving unit 2 includes a first capacitor C1, a second capacitor C2, a first resistor R1, a second resistor R2, a comparator 30, and a reference generator 20.

The receiving unit 2 filters the first sawtooth-wave signal V1 and the second sawtooth-wave signal V2 respectively, and generates an output signal OUT according to a result of comparison between the filtered signals. The receiving unit 2 generates a first pulse signal V3 and a second pulse signal V4 by respectively filtering the first sawtooth-wave signal V1 and the second sawtooth-wave signal V2.

The receiving unit 2 uses the capacitors C1 and C2 to filter the first sawtooth-wave signal V1 and the second sawtooth-wave signal V2 respectively to the first pulse signal V3 and the second pulse signal V4. When the first pulse signal V3 is high level and the second pulse signal V4 is low level, a current path flowing through the second resistor R2 from the first resistor R1 is formed. On the contrary, when the first pulse signal V3 is low level and the second pulse signal V4 is high level, a current path flowing through the first resistor R1 from the second resistor R2 is formed.

Also, the receiving unit 2 includes a reference generator 20 that maintains the reference voltage VR with a constant level by generating a compensation current to eliminate a current generated due to a common-mode noise or a common-mode transient signal. For example, generation of the common-mode noise or common-mode transient signal may cause the first sawtooth-wave signal V1 and the second sawtooth-wave signal V2 to be simultaneously generated as signals of the same direction (e.g., a positive direction or a negative direction). Then, a current path between the node N1 and the reference generator 20 and a current path between the node N2 and reference generator 20 are formed so that the reference voltage VR of the node N3 can be maintained with a constant level. Thus, change of the reference voltage VR due to of the common-mode noise or common-mode transient signal can be prevented. The receiving unit 2 generates the output signal OUT according to the result of comparison between the first pulse signal V3 and the second pulse signal V4.

The first capacitor C1 includes a first end to which the first sawtooth-wave signal V1 is input and a second end connected to the node N1. The second capacitor C2 includes a first end to which the second sawtooth-wave signal V2 is input and a second end connected to the node N2.

The first resistor R1 is connected between the node N1 and the node N3, and the second resistor R2 is connected between the node N2 and the node N3.

The comparator 30 includes a non-inverse terminal (+) connected to the node N1 and an inverse terminal (−) connected to the node N2. The comparator 30 has a hysteresis characteristic, and a voltage variation occurring in inputs of the comparator 30 is lower than a predetermined threshold voltage, the voltage variation can be ignored. That is, when the voltage change of the first pulse signal V3 and the voltage change of the second pulse signal V4 are respectively lower than the threshold voltage, the comparator 30 uses the output signal OUT without any change.

The threshold voltage may be set to a voltage that is higher than the voltage change occurring in the first pulse signal V3 by a less steeper slope between the increasing slope and the decreasing slope of the first sawtooth-wave signal V1 and the voltage change occurring in the second pulse signal V4 by a less steeper slope between the increasing slope and the decreasing slope of the second sawtooth-wave signal V2.

The comparator 30 outputs a high-level output signal OUT when an input of the non-inverse terminal (+) is higher than an input of the inverse terminal (−), and outputs a low-level output signal OUT when the input of the non-inverse terminal (+) is lower than the input of the inverse terminal (−).

When the first pulse signal V3 and the second pulse signal V4 are pluses of the same direction, the reference generator 20 generates a source current or a sink current depending on the direction to prevent distortion of the output signal OUT due to the common-mode noise or common-mode transient signal.

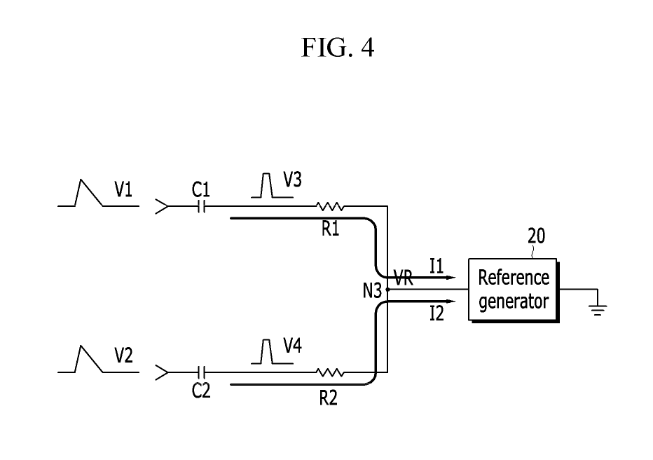

FIG. 4 shows a current path formed when the common-mode noise is generated in the positive direction for description of the exemplary embodiment.

As shown in FIG. 4, the first sawtooth-wave signal V1 and the second sawtooth-wave signal V2 have waveforms that increases and then decrease by the common-mode noise generated in the positive direction. Then, the first pulse signal V3 and the second pulse signal V4 become high-level pulses so that the reference voltage VR of the node N3 is rapidly increased. Then, the reference generator 20 generates a first sink current 11 and a second sink current 12 to attenuate the high-level pulses of the first pulse signal V3 and the second pulse signal V4 to thereby maintain the reference voltage VR with a constant level.

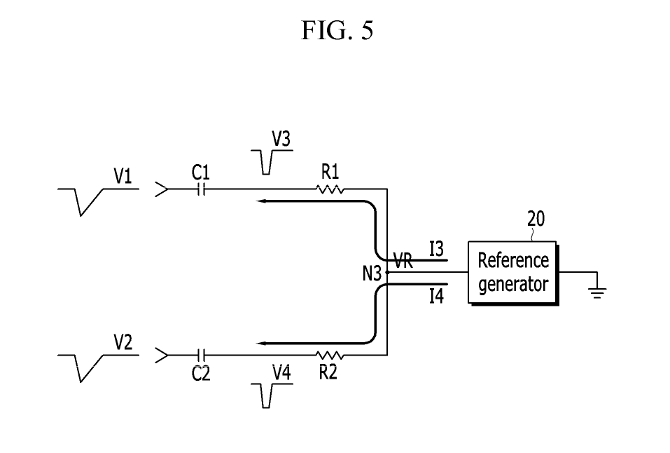

FIG. 5 shows a current path formed when the common-mode noise is generated in the negative direction for description of the exemplary embodiment.

As shown in FIG. 5, the first sawtooth-wave signal V1 and the second sawtooth-wave signal V2 have waveforms that decrease and then increase by the common-mode noise generated in the negative direction. Then, the first pulse signal V3 and the second pulse signal V4 become low-level pulses so that the reference voltage VR of the node N3 is rapidly decreased.

Then, the reference generator 20 generates the first source current 13 and the second source current 14 to attenuate the low-level pulses of the first pulse signal V3 and the second pulse signal V4 to thereby maintain the reference voltage VR with a constant level.

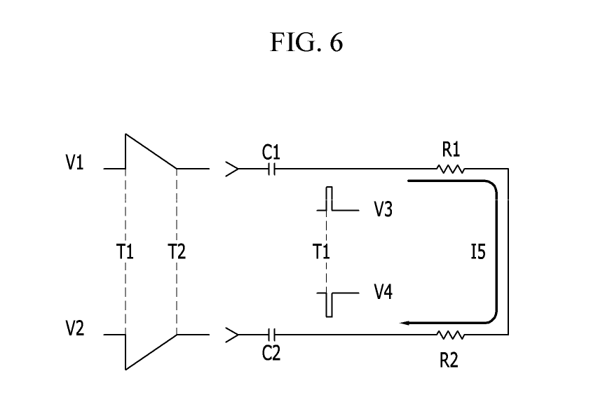

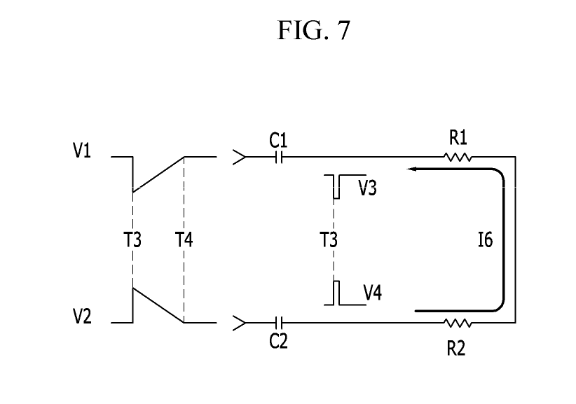

Hereinafter, a method for transmitting and receiving data of the communication device will be described with reference to FIG. 2, FIG. 3, FIG. 6, and FIG. 7.

FIG. 6 shows a current path in transmitting and receiving of data 1 according to the exemplary embodiment.

FIG. 7 shows a current path in transmitting and receiving of data 0 according to the exemplary embodiment.

As shown in FIG. 2, when the input signal IN is data 1, the first sawtooth-wave signal V1 is increased to high level at a time T1 and decreased with a first slope during a period T1 to T2, and the second sawtooth-wave signal V2 is decreased to low level at the time T1 and increased with a second slope during the period T1 to T2.

The first sawtooth-wave signal V1 increased at the time T1 increases a voltage of the node N1 through the first capacitor C1, and a high-level first pulse signal V3 is generated by being synchronized at the time T1.

The second sawtooth-wave signal V2 decreased at the time T1 decreases a voltage of the node N2 through the second sawtooth-wave signal V2, and a low-level second pulse signal V4 is generated by being synchronized at the time T1.

Then, as shown in FIG. 6, a current 15 flowing to the node N2 is generated from the node N1 through the first resistor R1 and the second resistor

R2.

Since the first pulse signal V3 is higher than the second pulse signal V4 at the time T1, the comparator 30 generates a high-level output signal OUT.

As shown in FIG. 3, when the input signal IN is data 0, the first sawtooth-wave signal V1 is decreased to low level at a time T3 and increased with a third slope during a period T3 to T4, and the second sawtooth-wave signal V2 is increased to high level at the time T3 and decreased with a fourth slope during the period T3 to T4.

The first sawtooth-wave signal V1 decreased at the time T3 decreases the voltage of the node N1 through the first sawtooth-wave signal V1, and a low-level pulse signal V3 is generated by being synchronized at the time T3.

The second sawtooth-wave signal V2 increased at the time T3 increases the voltage of the node N2 through the second sawtooth-wave signal V2, and a high-level second pulse signal V4 is generated by being synchronized at the time T3.

Then, as shown in FIG. 7, a current 16 flowing to the node N1 from the node N2 through the second resistor R2 and the first resistor R1 is generated.

Since the first pulse signal V3 is lower than the second pulse signal V4 at the time T3, the comparator 30 generates a low-level output signal OUT.

As described, when the input signal IN is data 1, a high-level output signal OUT is output, and when the input signal IN is data 0, a low-level output signal OUT is ouput.

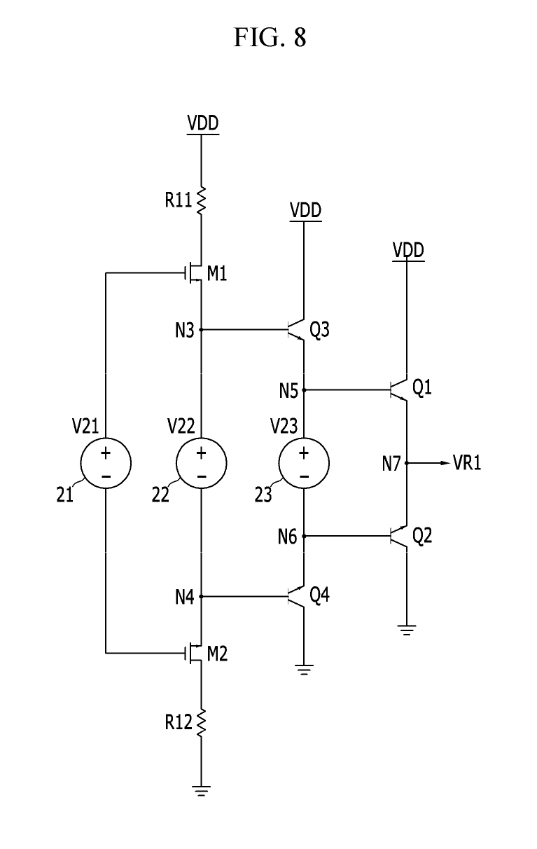

Hereinafter, the reference generator according to the exemplary embodiment will be described with reference to FIG. 8.

FIG. 8 partially shows the reference generator according to the exemplary embodiment. As shown in FIG. 8, the reference generator 20 includes a Darlington pair used in a push-pull structure together with a source follower. The reference generator 20 may include first to third control voltage sources 21 to 23, two resistors R11 and R12, four bipolar junction transistors (BJT) Q1 to Q4, and two metal-oxide semiconductor field-effect transistors (MOSFET) M1 and M2. The BJT Q1 and the BJT Q3 form a first Darlington pair and the BJT Q2 and the BJT Q4 form a second Darlington pair. The MOSFET M1 and the MOSFET M2 are source followers.

The reference voltage VR, which is an output of the reference generator 20, may be controlled according to the resistor R1 and the resistor R2. A standby-current can be controlled by controlling the first to third control voltage sources 21 to 23.

A positive voltage of the first control voltage source 21 is connected to a gate of the MOSFET M1, and a negative voltage of the first control voltage source 21 is connected to a gate of the MOSFET M2. The positive voltage implies a relative high voltage among voltages supplied from the first control voltage source 21, and the negative voltage implies a relatively low voltage among voltages supplied from the first control voltage source 21. Hereinafter, the positive voltage and the negative voltage imply relative high and low of the voltage.

The MOSFET M1 is an n-channel transistor and the MOSFET M2 is a p-channel transistor.

A drain of the MOSFET M1 is connected to a voltage VDD through the resistor R11, and a source of the MOSFET M1 is connected to the node N3. A drain of the MOSFET M2 is connected to a ground through the resistor R12 and a source of the MOSFET M2 is connected to the node N4.

The node N3 is an input terminal of the Darlington pair formed of the BJT Q1 and the BJT Q3 and the node N4 is an input terminal of the Darlington pair formed of the BJT Q2 and the BJT Q4, and output terminals of the two Darlington pairs are connected to an output node N7.

A positive voltage of the second control voltage source 22 is connected to a base of the BJT Q3 and a negative voltage of the second control voltage source 22 is connected to a base of the BJT Q4. The BJT Q3 is an npn-type transistor and the BJT Q4 is a pnp-type transistor. In addition, the base of the BJT Q3 is connected to the node N3 and the base of the BJT Q4 is connected to the node N4. A collector of the BJT Q3 is connected to a voltage VDD and an emitter of the BJT Q3 is connected to the node N5 and a base of the BJT Q1. An emitter of the BJT Q4 is connected to the node N6 and a base of the BJT Q2 and a collector of the BJT Q4 is connected to the ground.

A positive voltage of the third control voltage source 23 is connected to the base of the BJT Q1 and a negative voltage of the third control voltage source 23 is connected to the base of the BJT Q2. The BJT Q1 is an npn-type transistor and the BJT Q2 is a pnp-type transistor.

In addition, the base of the BJT Q1 is connected to the node N5 and the base of the BJT Q2 is connected to the node N6. The collector of the BJT Q1 is connected to a voltage VDD and an emitter of the BJT Q1 is connected to the output node N7. An emitter of the BJT Q2 is connected to the output node N7 and a collector of the BJT Q2 is connected to the ground. The reference voltage VR is generated from the output node N7.

Hereinafter, operation of the reference generator 20 illustrated in FIG. 8 will be described.

First, an idle state during which either increase nor decrease of the first sawtooth-wave signal V1 and the second sawtooth-wave signal V2 occur will be described.

A voltage of the reference voltage VR is expressed as given in Equation 1 and Equation 2.

VR1=VDD−V11−Vds1−Vbe3−Vbe1, [Equation 1]

Here, V11 is a both-end voltage of the resistor R11, Vds1 is a drain-source voltage of the MOSFET M1, Vbe3is a base-emitter voltage of the BJT3, and Vbe1 is a base-emitter voltage of the BJT Q1.

VR1=0+V12+Vds2+Vbe4+Vbe2 [Equation 2]

Here, V12 is a both-end voltage of the resistor R12, Vds2 is a drain-source voltage of the MOSFET M2, Vbe4 is a base-emitter voltage of the BJT Q4, and Vbe2 is a base-emitter voltage of the BJT Q2. When the Vds of each of the MOSFET M1 and the MOSFET M2 are low voltages and the Vbe of each of the BJTs Q1 to Q4 is almost 0.7V in the idle state, the reference voltage VR is determined by the V11 and the V12. However, the VDD is high enough compared to 0.7V or Vds. If the resistor R11 and the R12 are the same, an idle state voltage of the reference voltage VR is substantially the half of the VDD.

The third control voltage source 23 supplies a voltage V23 that is lower than the sum of the Vbe1, which is the base-emitter voltage of the BJT Q1 and the Vbe2, which is the base-emitter voltage of the BJT2 Q2. Then, a base-emitter current of the BJT Q1 and a base-emitter current of the BJT Q2 barely exist or do not exist. Thus, a very few amount of current passes through the output node N7.

The second control voltage source 22 supplies a voltage V22 that is lower than the sum of the base-emitter voltage Vbe3 of the BJT Q3 and the base-emitter voltage Vbe4 of the BJT Q4. Then, a current barely flows or no current flows to the third control voltage source 23.

The first control voltage source 21 is set to a predetermined voltage, so that only the minimum current (e.g., Iqg) that can generate a voltage to both ends of each of the resistor R11 and the resistor R12 is allowed to flow. When the current Iq flows, a voltage V21 of the first control voltage source 21 is set to about a voltage of approximately Vgsq1+Vsgq2+V22. The Vgsq1 is a gate-source voltage of the MOSFET M1 when the current Iq flows to the MOSFET M1, and the Vsgq2 is a source-gate voltage of the MOSFET M2 when the current Iq flows to the MOSFET M2.

As described, the voltage V23 of the third control voltage source 23 is set to generate voltages in the resistor R11 and the resistor R12 in the idle state, and therefore a current flowing to the second control voltage source 22 may be greater than a current passing through the third control voltage source 23 and the output node N7. The first control voltage source 21 is connected only to the gates of the MOSFETs M1 and M2, and therefore no current flows.

The voltage of each of the first to third control voltage sources 21 to 23 is set as described above so that a current can be controlled as follows.

First, the third control voltage source 23 is set as described above so that no current flows to the BJT Q1 and the BJT Q2 and flows to the third control voltage source 23 by a small current flowing to the BJT Q3 and the BJT Q4.

In addition, the second control voltage source 22 is set as described above so that the current flowing to the BJT Q3, the third control voltage source 23, and BJT Q4 can be set to be very small. The power consumption can be minimized by minimizing the current flowing to the BJTs Q1 to Q4. Then, the power consumption in the idle state can be minimized.

As shown in FIG. 5, when the first sawtooth-wave signal V1 and the second sawtooth-wave signal V2 are decreased and thus the first pulse signal V3 and the second pulse signal V4 are decreased, the reference voltage VR is also decreased. Then, a base-emitter voltage of the BJT Q1 becomes higher than the threshold voltage so that the BJT Q1 is turned on.

Then, the current flowing to the third control voltage source 23 in the idle state flows to between the base and the emitter of the BJT Q1. In this case, the current flowing to between the base and the emitter of the BJT Q1 is amplified and thus a current flows to between a collector and the emitter of the BJT Q1.

When the degree of decrease of the reference voltage VR is low enough to simultaneously turn on the BJT Q1 and the BJT Q3, the current flowing to the second control voltage source 22 in the idle state flows to between a base and an emitter of the BJT Q3. The current flowing between the base and the emitter of the BJT Q3 is amplified and thus a current flows to between the collector and the emitter of the BJT Q1.

When the reference voltage VR is decreased with a greater degree, the gate-source voltage of the MOSFET M1 is increased and thus a much more current flows between the base and the emitter of the BJT Q3. In this case, a voltage at the resistor R11 is also increased.

As shown in FIG. 4, when the first sawtooth-wave signal V1 and the second sawtooth-wave signal V2 are increased and thus the first pulse signal V3 and the second pulse signal V4 are increased, the reference voltage VR is also increased. Then, the emitter-base voltage of the BJT Q2 becomes higher than the threshold voltage and thus the BJT Q2 is turned off.

Accordingly, the current flowing to the third control voltage source 23 in the idle state is decreased, and a current flowing to between the emitter and the base of the BJT Q2 is generated. In this case, the current flowing to between the emitter and the base of the BJT Q2 is amplified and thus a current flows to between the emitter and a collector of the BJT Q2.

When the degree of increase of the reference voltage VR is high enough to simultaneously turn on the BJT Q2 and the BJT Q4, the current flowing to the second control voltage source 22 in the idle state is decreased and a current flows to between an emitter and a base of the BJT Q4. The current flowing to between the emitter and the base of the BJT Q4 is amplified by the BJT Q4 and the BJT Q2 and thus a current flows to the emitter and the collector of the BJT Q2.

When the degree of increase of the reference voltage VR is further high, a source-gate voltage of the MOSFET M2 is increased and thus a much more current flows to between the emitter and the base of the BJT Q4. In this case, a voltage at the resistor R12 is also increased.

The communication device according to the exemplary embodiment perform data transmitting and receiving using an analog signal such as a sawtooth wave, and therefore the structure is much simpler than that of a digital pulse. In addition, a current consumption for generation of a reference signal can be minimized.

In the exemplary embodiment, the sawtooth wave has been described as an example of the analog signal, but the present invention is not limited thereto. Any signal of which an increasing slope and a decreasing slope are changed according to an input signal IN is applicable.

For example, a waveform of an analog signal should changed according to an input signal IN, and the absolute value of an increasing slope and the absolute value of a decreasing slope of the analog signal should be different from each other.

In addition, torsion of an output signal can be prevented by blocking variation of a reference signal due to a common-mode noise or a common-mode transient signal. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

communication device 1, receiving unit 2

transmitting unit 3, sawtooth-wave generator 10

first capacitor C1, second capacitor C2

first resistor R1, second resistor R2

comparator 30, reference generator 20

first to third control voltage source 21-23

resistor R11 and R12, BJT Q1 to Q4

MOSFET M1 and M2

What is claimed is:

1. A communication device comprising:
a transmitting unit configured to generate a first analog signal and a second analog signal based on an input signal; and
a receiving unit including a first capacitor having a first terminal to which the first analog signal is input and a second capacitor having a first terminal to which the second analog signal is input, the receiving unit configured to control a reference voltage electrically coupled with a second terminal of the first capacitor and a second terminal of the second capacitor, and configured to generate an output signal based on a result of a comparison between a first pulse signal generated at the second terminal of the first capacitor and a second pulse signal generated at the second terminal of the second capacitor.

2. The communication device of claim 1, wherein the receiving unit includes a comparator configured to compare the first pulse signal with the second pulse signal and to output a result of the comparison.

3. The communication device of claim 2, wherein the receiving unit further comprises:
a first resistor coupled between the second terminal of the first capacitor and the reference voltage; and
a second resistor coupled between the second terminal of the second capacitor and the reference voltage, and
wherein the first pulse signal is generated from a node to which the first capacitor and the first resistor are coupled and the second pulse signal is generated from a node to which the second capacitor and the second resistor are coupled.

4. The communication device of claim 3, wherein the comparator is configured to ignore a voltage variation generated in inputs of the comparator when the voltage variation is lower than a predetermined threshold voltage.

5. The communication device of claim 4, wherein the threshold voltage is set to be a voltage that is greater than a voltage variation generated in the first pulse signal by a smaller slope among an increasing slope and a decreasing slope of the first sawtooth wave signal and a voltage variation generated in the second pulse signal by a smaller slope among an increasing slope and a decreasing slope of the second sawtooth wave signal.

6. The communication device of claim 1, wherein the receiving unit further comprises a reference generator configured to generate the reference voltage, the reference generator including,
an output node at which the reference voltage is generated,
a first Darlington pair having an output terminal coupled to the output node and configured to control the reference voltage if the first analog signal is decreased,
a second Darlington pair having an output terminal coupled to the output node and configured to control the reference voltage if the first analog signal is increased,
a first source follower having an output terminal coupled to an input terminal of the first Darlington pair,
a second source follower having an output terminal coupled to an input terminal of the second Darlington pair, and
a first control voltage source coupled between the input terminal of the first source follower and the input terminal of the second source follower.

7. The communication device of claim 6, wherein the reference generator further comprises:
a third resistor coupled between the first source follower and a first voltage; and
a fourth resistor coupled between the second source follower and a reference potential.

8. The communication device of claim 7, wherein a voltage of the first control voltage source is set to control the minimum amount of current to be generated from later ends of each of the third and fourth resistors.

9. The communication device of claim 7, wherein
the second source follower includes a first MOSFET having a drain coupled to a first end of the third resistor, a gate to which a second voltage of the first control voltage source is supplied, and a source coupled to an input terminal of the first Darlington pair, and
the second source follower includes a second MOSFET having a drain coupled to a first end of the fourth resistor, a gate to which a third voltage of the first control voltage source is supplied, and a source coupled to an input terminal of the second Darlington pair.

10. The communication device of claim 9, wherein a second end of the third resistor is coupled to the first voltage and a second end of the fourth resistor is coupled to a reference potential.

11. The communication device of claim 6, wherein the first Darlington pair includes a first BJT having an emitter coupled to the output node, a collector coupled to a first voltage, and a base coupled to a first node, and a third BJT having an emitter coupled to the first node, a collector coupled to the first voltage, and a base coupled to an input terminal of the first Darlington pair.

12. The communication device of claim 11, wherein the second Darlington pair includes a second BJT having an emitter coupled to the output node, a collector coupled to a reference potential, and a base coupled to a second node, and a fourth BJT having an emitter coupled to the second node, a collector coupled to the reference potential, and a base coupled to an input terminal of the second Darlington pair.

13. The communication device of claim 12, wherein the reference generator further comprises a third control voltage source coupled between the first node and the second node, a voltage of the third control voltage source set to be lower than the sum of a voltage difference between the base and the emitter of the first BJT and a voltage difference between the base and the emitter of the second BJT.

14. The communication device of claim 13, wherein the reference generator further comprises a second control voltage source coupled between the input terminal of the first Darlington pair and the input terminal of the second Darlington pair, a voltage of the second control voltage source set to be lower than the sum of a voltage difference between the base and the emitter of the third BJT, a voltage difference between the base and the emitter of the fourth BJT, and the voltage of the third control voltage source.

15. The communication device of claim 1, wherein the first analog signal depends on one of a first waveform and a second waveform based on the input signal, the absolute value of an increasing slope and the absolute value of a decreasing slope of the first analog signal being different from each other in the first waveform, and the absolute value of the increasing slope and the absolute value of the decreasing slope of the first analog signal being different from each other in the second waveform.

16. The communication device of claim 1, wherein the second analog signal depends on one of a third waveform and a fourth waveform based on the input signal, the absolute value of an increasing slope and the absolute value of a decreasing slope of the second analog signal being different from each other in the third waveform, and the absolute value of the increasing slope and the absolute value of the decreasing slope of the second analog signal being different from each other in the fourth waveform.

17. The communication device of claim 1, wherein the receiving unit further comprises:
a first resistor coupled between the second end of the first capacitor and the reference voltage;
a second resistor coupled between the second end of the second capacitor and the reference voltage; and
a reference generator configured to generate a current to offset a pulse of the first pulse signal and a pulse of the second pulse signal when the pulse of the first pulse signal and the pulse of the second pulse have the same direction.

18. The communication device of claim 17, wherein, when both of the first pulse signal and the second pulse signal have high-level pulses, the reference generator is configured to generate a first sink current flowing to the reference generator through the first resistor and a second sink current flowing to the reference generator through the second resistor.

19. The communication device of claim 17, wherein, when both of the first pulse signal and the second pulse signal have low-level pulses, the reference generator is configured to generate a first source current flowing to the second end of the first capacitor through the first resistor and a second source current flowing to the second end of the second capacitor through the second resistor.

20. The communication device of claim 17, wherein the receiving unit further comprises a comparator having a first input terminal to which the first pulse signal is input and a second input terminal to which the second pulse signal is input, the comparator configured to generate the output signal based on a result of comparison between the first pulse signal and the second pulse signal, and to ignore a voltage variation generated in the first pulse signal and the second pulse signal when the voltage variation is lower than a predetermined threshold voltage.

21. The communication device of claim 17, wherein, when the input signal indicates data 1, a current flows to the second end of the second capacitor from the second end of the first capacitor through the first resistor and the second resistor.

22. The communication device of claim 17, wherein, when the input signal indicates data 0, a current flows to the second end of the first capacitor from the second end of the second capacitor through the second resistor and the first resistor.
